(19) United States
(12) Patent Application Publication
(10) Pub. No.: US 2002/0099614 A1
(43) Pub. Date: Jul. 25, 2002

(54) System and method for selling and distributing consumer products

(76) Inventor: Warren W. Krech, Inver Grove Heights, MN (US)

Correspondence Address: MERCHANT & GOULD PC, P.O. BOX 2903, MINNEAPOLIS, MN, 55402-0903, US

(21) Appl. No.: 09/766,326

(22) Filed: Jan. 19, 2001

(51) Int. Cl. G06F 17/60

(52) U.S. Cl. 705/26

(57) ABSTRACT

A retail store-based system and method for selling and distributing products to a customer using a collection of two or more on-line vendors available within one or more retail stores is disclosed. The retail facility has an affiliation with each of the vendors offering products. The system can comprise a collection of ordering appliances situated and arranged at the retail facility. Each of the ordering appliances can be configured to display content offerings to a customer and receive order information from the customer placing an order for one or more consumer products offered by the vendors. Furthermore, the system can comprise an order management subsystem in data communication with each of the ordering appliances. The order management subsystem can comprise an order processor that is configured to interface each of the ordering appliances with a vendor computing system associated with each of the vendors.

### TECHNICAL FIELD

The present invention relates to a system and method for selling and distributing consumer products to a customer, and more particularly, the present invention relates to a retail store-based system and method for selling and distributing products to a customer using a collection of two or more on-line vendors available within one or more retail stores.

### BACKGROUND

Various systems and methods for selling and distributing products are known. In many existing systems, the customer selects items and takes delivery from an inventory of items available in a retail store. In other cases, the customer can place an order (either in person, via mail, or via an electronic medium) with a retail store for delivery directly to his/her home, or the customer can arrange to pick up his/her order from one of various locations.

While the present retail store methods are generally reliable, they are often inefficient and expensive. These limitations require that large retail stores locate in areas with large concentrations of customers, such as large malls or large superstores. The limited number of store locations and the large size of the facilities lead to travel time and in-store time that cause customer inconvenience.

Recently, on-line vendors have offered products for sale at their on-line web sites. These products can be selected from a virtual offering and ordered on-line, for delivery to the customer's home or other location arranged by the customer. Portals often gather together links to many on-line vendors, and thus advertise the vendors for a fee or a commission. New methods called “business web” methods are being developed to embed an on-line vendor site into many on-line partner sites.

Similarly, some traditional retailers have provided in-store access to their on-line web sites. For example, some retailers have provided dedicated computers that allow customers to access the retailer's on-line web site. In so doing, these retailers provide an additional sales channel or source of additional information for ordering products that may not be available within the retail store.

On-line vendors are often unknown or without a personal connection to the customer. Concern for receipt of unsatisfactory products and the difficulty of returning unsatisfactory products is a barrier to customer satisfaction. Without personal interaction with sales associates, the on-line sales method lacks the ability to give advice, offer assistance, or answer questions in a personal manner. Because of the impersonal nature of the virtual store and the customer's inability to directly examine the products before purchasing, many consumers are reluctant to utilize on-line vendors. Moreover, existing retailers offering in-store access to on-line web sites are limited because the products being offered are available from their own product line. Accordingly, the customer's ability to efficiently purchase a variety of products from a collection of vendors within a single retail facility is not possible.

Improvements through a new system and method for the sale and distribution of consumer products are, therefore, sought.

### SUMMARY

In general terms, the present disclosure relates to a system and method for selling and distributing consumer products. More particularly, the present disclosure relates to a retail store-based system and method for selling and distributing products to a customer using a collection of two or more on-line vendors available within one or more retail stores.

In one aspect of the disclosure, the retail facility offers products from vendors affiliated with the retail facility. The retail facility can comprise a network of retail facilities wherein each of the retail facilities within the network has an affiliation with more than one of the vendors. The system can comprise a collection of ordering appliances situated and arranged at the retail facility. Each of the ordering appliances can be configured to display content offerings to the customer and to receive order information from the customer placing an order for one or more consumer products available from the vendors. Furthermore, the system can comprise an order management subsystem in data communication with each of the ordering appliances. The order management subsystem can comprise an order processor that is configured to interface each of the ordering appliances with a vendor computing system associated with each of the vendors.

Further in this aspect, the order processor can be configured to interface with a translator capable of dynamically managing the affiliation between the retail facility and each of the vendor computing systems. The translator can comprise a business web embedded within the order processor and further can be configured to tailor the content offerings to each retail facility in accordance with the affiliation established between the retail facility and each of the vendors.

Still further in this aspect, each of the ordering appliances can be situated and arranged proximate to one or more product samples. Each of the product samples is preferably representative of a complete product offering available from the vendors.

In another aspect of the disclosure, a method of selling and distributing consumer products within a retail facility is provided. The consumer products are offered by the retail facility from vendors affiliated with the retail facility. The method comprises providing a collection of ordering appliances situated and arranged at the retail facility; displaying content offerings associated with one of the vendors to at least one of the ordering appliances; receiving order information from a customer placing an order for one or more consumer products being offered by one of the more than one vendors; and interfacing with each of the ordering appliances and a vendor computing system associated with each of the two or more vendors via a computing network to facilitate the fulfillment of the order.

In this aspect, interfacing with each of the ordering appliances and the vendor computing systems can include interfacing with a translator that is capable of dynamically managing the affiliation between the retail facility and each of the vendor computing systems. Interfacing with the translator can further comprise tailoring the content offerings to the retail facility in accordance with the affiliations established between the retail facility and vendors. In so doing, the content offerings can be tailored according to demographic information gathered for the retail facility.

Still further in this aspect, the method can further comprises varying the content offerings according to the needs of each retail facility within the network of retail facilities. Moreover, the method can further comprise arranging each of the ordering appliances proximate to one or more product samples wherein each of the product samples are preferably representative of a complete product offering available from one of the two or more vendors. The method further comprises the availability of sales associates to assist customers with product selection and with the ordering process.

### BRIEF DESCRIPTION OF THE DRAWINGS

The invention may be more completely understood in consideration of the following detailed description of various embodiments of the invention in connection with the accompanying drawings, in which:

FIG. 1 is a high-level diagram illustrating a system and method for selling and distributing consumer products in accordance with the present disclosure;

FIG. 2 is a high-level diagram illustrating a system for managing the sale and distribution of consumer products within a retail facility in accordance with the present disclosure;

FIG. 3 is a more detailed diagram illustrating the system for managing the sale and distribution of consumer products shown in FIG. 2;

FIG. 4 is a diagram illustrating an exemplary system architecture capable of supporting the system and method for selling and distributing consumer products in accordance with the present disclosure;

FIG. 5 illustrates an exemplary server computing system capable of implementing the logical operations of the system and method for selling and distributing consumer products in accordance with the present disclosure;

FIG. 6 illustrates an exemplary ordering appliance capable of communicating with the system and method for selling and distributing consumer products shown in FIG. 2;

FIG. 7 is a schematic diagram depicting one possible embodiment of the various components comprising the system and method for selling and distributing consumer products shown in FIG. 2;

FIG. 8 is a diagram illustrating several of the possible delivery modalities available with the system and method for selling and distributing consumer products shown in FIG. 2; and

FIG. 9 is a high-level flow chart illustrating the logical operations of the computing system for selling and distributing consumer products in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention will be described in detail with reference to the drawings, wherein like reference numerals represent like parts and assemblies throughout the several views. Reference to various embodiments does not limit the scope of the present invention, which is limited only by the scope of the claims attached hereto.

The following discussion is intended to provide a brief, general description of a suitable environment for implementing the system and method of the present disclosure. It should be recognized that the system and method of the present disclosure may be practiced with many computer system configurations and platforms, such as hand-held computers or devices, laptop computers, desktop computers, or network personal computers.

The embodiments of the present computing system are implemented as logical operations in a distributed processing system having client and server computing systems. The logical operations of the present computing system are implemented: (1) as a sequence of computer implemented steps running on the computing system; and (2) as interconnected machine modules within the computing system. The implementation is a matter of choice dependant on the performance requirements of the computing system implementing the computing system and the components selected by or utilized by the users of the system. Accordingly, the logical operations making up the embodiments of the computing system described herein are referred to variously as operations, steps, subsystems, or modules.

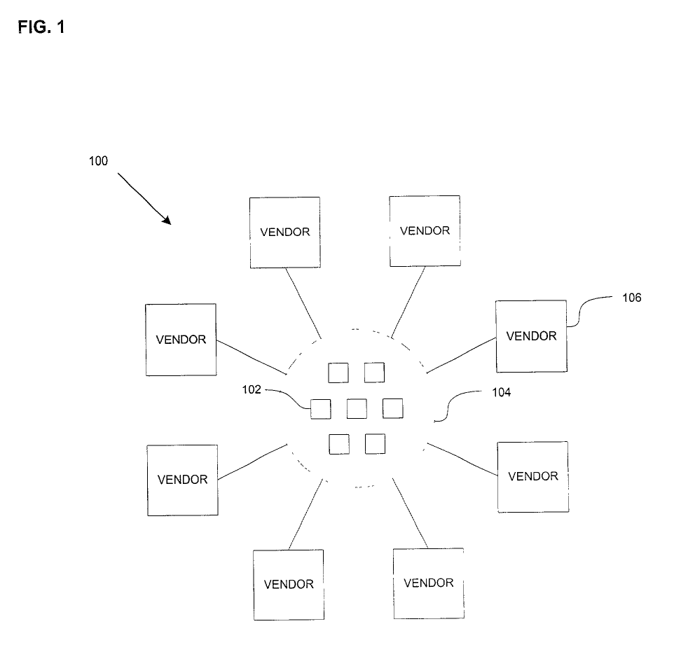

Referring now to FIG. 1, a high-level diagram of the system and method 100 for selling and distributing consumer products is illustrated. The phrase “consumer products” generally includes any product that is commercially available via traditional “bricks and mortar” vendors, catalog vendors, online vendors, or any other similar vendors offering goods for use or consumption by consumers. For example, consumer products that may be purchased using the system and method of the present disclosure include consumer household products, clothing, electronic products, books, jewelry, artwork or other collectibles, food products, cosmetics. as well as other similar products.

As shown in FIG. 1, the system and method 100 includes one or more retail facilities 102 operating in conjunction with more than one vendor 106. In one possible embodiment, the retail facilities 102 operate or exist as part of a network 104, such as a chain of franchises or other business organizations having some pre-defined relationship or association. However, it will be readily appreciated by those having skill in the art that the system and method of the present disclosure can be fully utilized with one or more independently operated retail facilities.

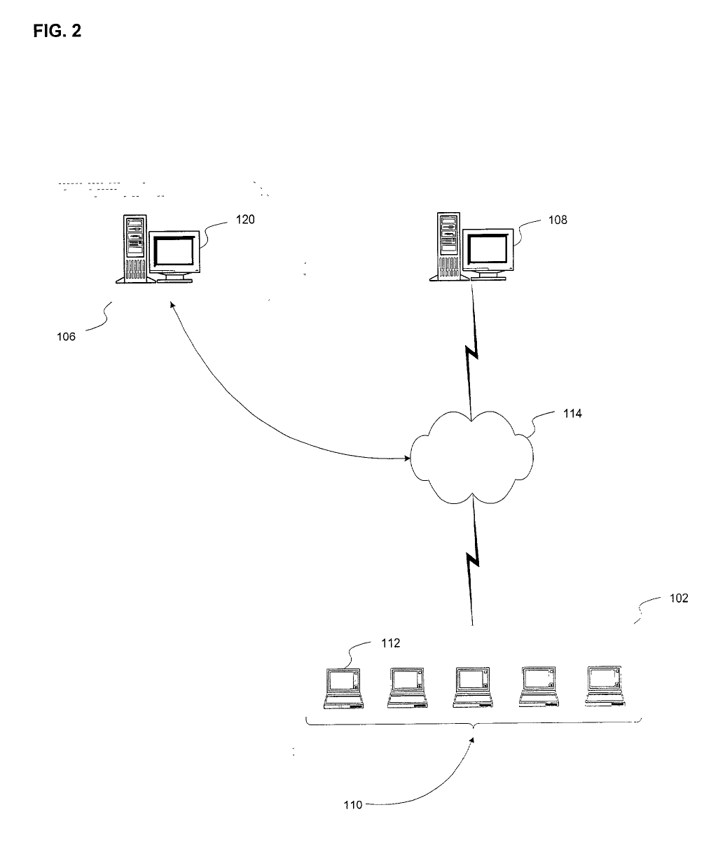

In the embodiment illustrated in FIG. 2, the system and method 100 (FIG. 1) generally includes a sales and distribution computing system 108 that facilitates the sale and distribution of consumer products. In particular, the sales and distribution computing system 108 effectuates the sale and distribution of consumer products made available by the retail facilities 102 or network of retail facilities 104 from vendors 106 having a pre-established affiliation with each of the retail facilities 102 or the network of retail facilities 104. The pre-established affiliation between the retail facilities 102 and each of the vendors 106 determines the content offerings available from each of the vendors 106 and is preferably established by each of the retail facilities 102 or network of retail facilities 104. The content offerings available from each of the vendors 106 generally can include a listing of available products, as well as other information relevant to the purchase of consumer products, such as, detailed product information, promotional offers, advertisements, and other similar information.

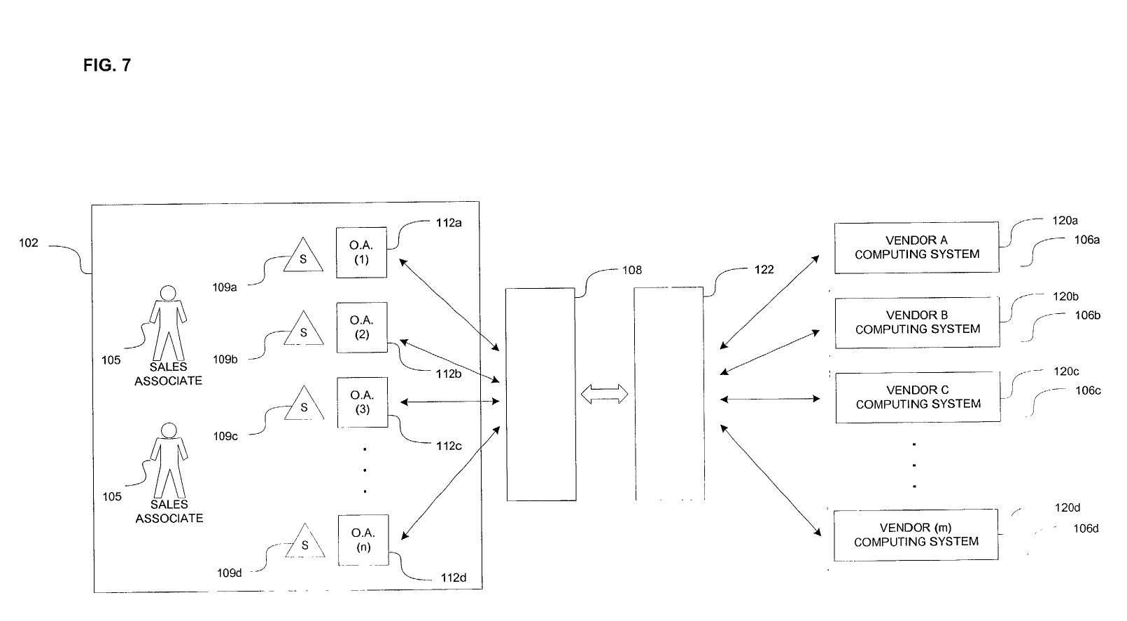

As shown in FIG. 2, the sales and distribution computing system 108 of the present disclosure communicates with a vendor computing system 120 for each vendor 106 to process a customer order and arrange and/or manage the fulfillment of the customer's order. A customer can access the sales and distribution computing system 108 to place an order by visiting one of the retail facilities 102. The retail facilities 102 are generally a retail location designed to provide quick and easy access to the sales and distribution computing system 108, thereby, enabling each customer to place an order in a time-efficient manner. For example, the retail facility 102 can be a convenience store, a retail area located in a mall environment, a retail area located within a grocery store, or other similar retail environment. The retail facilities 102 used in connection with the present disclosure will be discussed in greater detail below in connection with FIG. 7.

As further shown in FIG. 2, a collection of ordering appliances 110 is situated and arranged within each of the retail facilities 102. In one possible embodiment, a customer can initiate a single session for ordering products via the sales and distribution computing system 108 (e.g., using one of the ordering appliances 112) from a single vendor 106. In an alternative embodiment, however, a customer can order products via the sales and distribution computing system 108 (e.g., using one of the ordering appliances 112) from two or more vendors 106 during a single session. In either case, each of the ordering appliances 112 can be dedicated computing systems used by a customer for the purpose of accessing the sales and distribution computing system 108. The ordering appliances 112 can be touch screen kiosk-type devices that provide an interface to the sales and distribution computing system 108. Alternatively, the ordering appliances 112 can be any computing system capable of accessing the sales and distribution computing system 108, such as, an IBM-compatible personal computer, a laptop computer or workstation, a palm- or hand-held computer, or any other device that can be used to access the sales and distribution computing system 108. In either case, each of the ordering appliances 112 preferably includes a simple user interface, thereby, providing customers with efficient and easy access and use of the sales and distribution computing system 108.

In the illustrated embodiment, each of the ordering appliances 112 communicates with the sales and distribution computing system 108 via a communications network 114. In a preferred embodiment, the communications network 114 is the Internet. In an alternative embodiment, however, the communications network 114 is an intranet, local area network, wide area network, virtual private network, or other similar communications network capable of allowing a consumer to access the sales and distribution computing system 108 via one of the ordering appliances 112. Moreover, each of the ordering appliances 112 can access the sales and distribution computing system 108 using a variety of connection types. For example, each of the ordering appliances 112 can access the sales and distribution computing system 108 via a hard-wired connection, a direct-dial connection, a wireless connection (e.g., radio frequency or infrared), or other suitable connection types capable of allowing data communication between the ordering appliance 112 and the sales and distribution computing system 108.

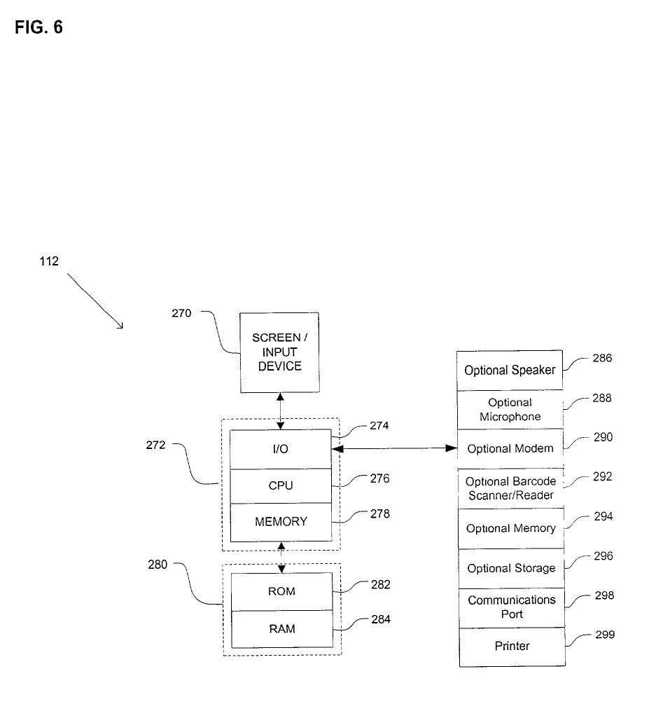

Each of the ordering appliances 112 typically has a resident operating system, such as those sold under the brand names Microsoft Windows™, Unix™, Linux™, DOS™, AIX™, or other similar operating systems. Furthermore, each of the ordering appliances 112 can also have a web browser installed for accessing and viewing content via the communications network 114, such as those sold under the brand names Microsoft Internet Explorer™ or Netscape Navigator™. The ordering appliances 112 will be discussed in greater detail below in connection with FIG. 6.

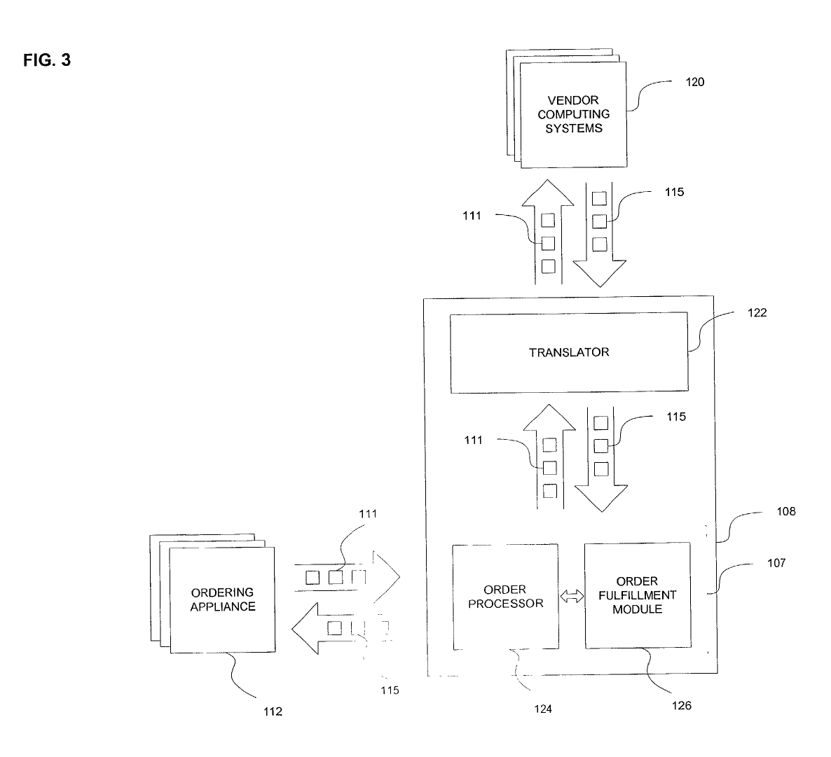

Now referring to FIG. 3, a block diagram illustrating the various components of the system and method of the present disclosure are shown. As illustrated in FIG. 3, the sales and distribution computing system 108 comprises an order management subsystem 107 in data communication with each of the ordering appliances 112 and a translator 122. The order management subsystem 107 can include an order processor 124 and an order fulfillment module 126. The order processor 124 is configured to display output to and receive input from each of the ordering appliances 112. In particular, the order processor 124 distributes content offerings 115 to each of the ordering appliances 112. As discussed above, the content offerings 115 generally can include a listing of available products, as well as other information relevant to the purchase of consumer products, such as, detailed product information, promotional offers, advertisements, and other similar information. Furthermore, the order processor 124 receives product order information 111 specified by a customer at one of the ordering appliances 112 in response to the product offerings 115. The product order information 111 generally can include any information relevant to the customer's purchase of one or more desired consumer products being offered by one of the vendors 106 (FIG. 1). For example, the product order information 111 generally can include a unique vendor identifier, a unique product identifier, desired quantity, delivery information, as well as other similar information.

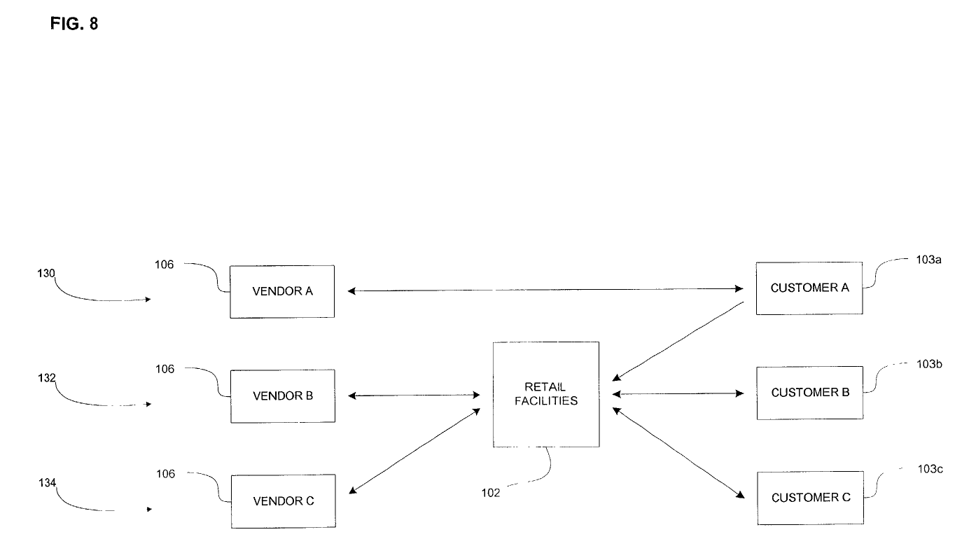

The order fulfillment module 126 is in data communication with the order processor 124 and is configured to track the fulfillment of the customer order from the customer-selected vendor 106. In particular, the order fulfillment module 126 coordinates the delivery of the customer order in accordance with one of the available delivery modalities selected by the customer. The order fulfillment module 126 and the available delivery modalities will be discussed in greater detail in connection with FIG. 8 below.

At each of the ordering appliances 112, the customer can access content offerings 115 available from one or more of the vendors 106. Once the customer has reached a purchasing decision, the customer can submit his/her product order information 111. Upon receipt of the customer's order information 111, the sales and distribution computing system 108 interfaces with the corresponding vendor computing system 120 to effectuate the sale and fulfillment of the customer's order. In particular, the vendor computing system 120 can confirm the customer's product order, the selected quantity, and delivery information. In the illustrated embodiment, the sales and distribution computing system 108 interfaces with each vendor computing system 120 using the translator 122. The translator 122 dynamically manages the interface or relationship between the sales and distribution computing system 108 and each of the third-party vendor computing systems 120. By “dynamically manages,” it is generally meant that the translator 122 tailors the content offerings 115 to each retail facility 102 or network of retail facilities 104, the customer, or both in real-time. Accordingly, when a change in the application interface or content offerings 115 is desired, the change can be implemented in a quick and easy manner with minimal effort (e.g., without hard-coded changes to software) required by the affected retail facilities 102. In one possible embodiment, the translator 122 is a business web generated in accordance with the Bowstreet™ Business Web Factory as described in the articles entitled “Stores Within Stores: Expanding Your Reach And Distribution Across the Internet,” (http://www.bowstreet.com/products/cobranding.htm) and “Bowstreet™ Business Web Factory: How Business Webs, Web Services and Automation are Transforming B2B Interactions on the Web” (http://www.bowstreet.com/products/AndyWhitePap-BWF.htm). The entire disclosure of each of these articles is hereby incorporated by reference.

The translator 122 can tailor the content offerings 115 to the retail facility 102 according to the affiliation established between the vendor 106 and the retail facility 102. For example, the content offerings 115 can be tailored to the retail facility 102 according to demographic information known about the area where the corresponding retail facility 102 is located. Similarly, the translator 122 can tailor the content offerings 115 to each customer according to known information gathered about each customer, such as, customer profile information gathered during an initial setup process or during each session. Accordingly, the translator 122 provides a tailored and seamless interface between the sales and distribution computing system 108 and each of the vendor computing systems 120.

In one possible embodiment, the content offerings 115 from each of the vendor computing systems 120 is embedded within the order processor 124. By “embedded,” it is generally meant vendor content offerings 115 are presented within a single application interface available at each of the ordering appliances 112 without the need to launch a second application. In so doing, marketing data, such as, customer usage as well as other demographic information, can be easily gathered and associated with a corresponding retail facility 102. As a result, the retail facilities 102 and each of the vendors 106 can easily and effectively measure the effectiveness of the corresponding affiliation.

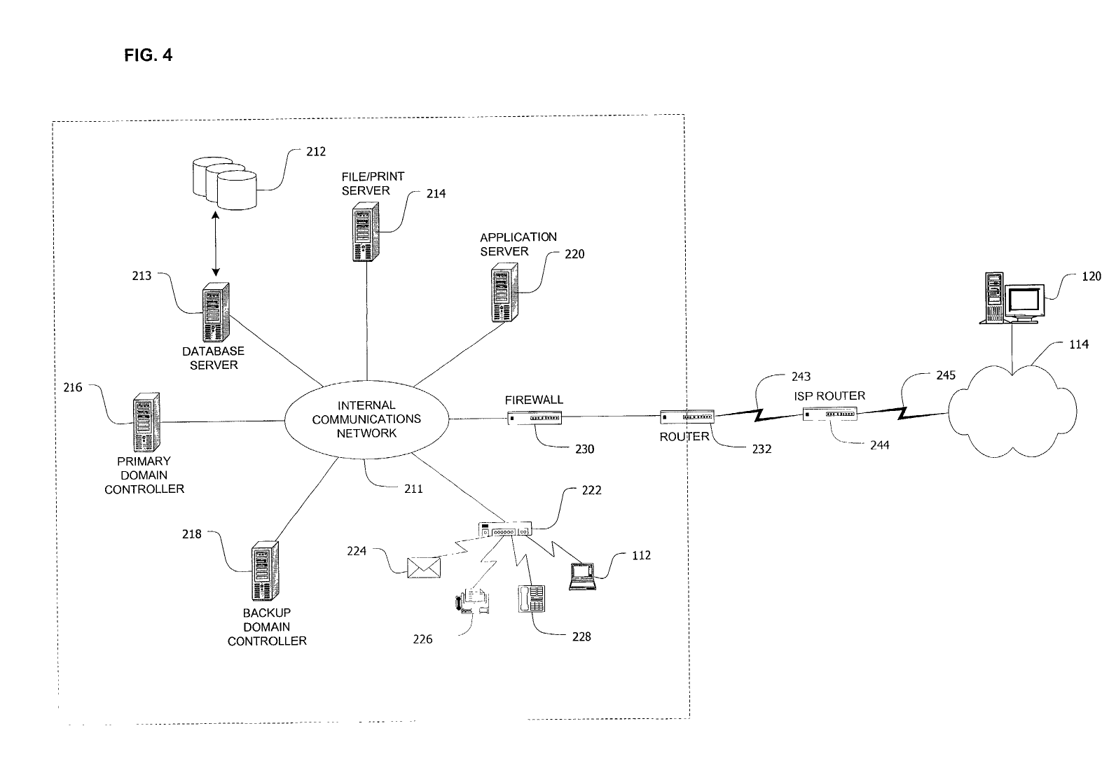

Now referring to FIG. 4, an exemplary system architecture that may be used to support the sales and distribution system is shown. As discussed above, the customer may access the sales and distribution computing system 108 (FIG. 1) via the communications network 114 (FIG. 2). In one possible embodiment, the communications network 114 is in data communication with a proprietary internal communications network 211. The internal communications network 211 can be an intranet, LAN, WAN, or any other suitable computing network. Alternatively, the communications network 211 can be provided by an application service provider (“ASP”) or hosting center.

The internal communications network 211 is configured to operate with several computing systems. The various computing systems that may be configured to operate with the internal communications network 211 may include, but are not limited to, a database server 213, a print/file server 214, a primary domain controller 216, a backup domain controller 218, an application server 220, and a communications server 222. Additionally, peripheral equipment (not shown), such as printers, storage devices, or workstation computers may be configured to operate with the communications network 211. It will be understood by those skilled in the art that many other configurations and arrangements of the network, servers, and/or the peripheral devices are possible.

The database server 213 manages the data 212 used by the sales and distribution computing system 108. The data 212 stored on the database server 213 can include profile information about each customer, such as product purchasing history, payment information, preferred delivery options, as well as other demographic information. The profile data about each customer can be used each subsequent time the customer accesses the sales and distribution system 108, thereby, streamlining the ordering process. Similarly, the data 212 stored on the database server 213 can include product information; such as available inventory, product specifications, pricing information, as well as other similar information.

The file/print server 214 stores and manages files accessible via the internal communications network 211. The file/print server 214 also manages the printing devices (not shown) that may be connected to the communications network 214. The primary domain controller 216 and the backup domain controller 218 manage the transfer of data between the various computing systems as well as other peripheral devices connected to the network 211. The application server 220 administers the application software comprising the sales and distribution system 102.

In one embodiment, the customer accesses the internal communications network 211 via the communications server 222 using the ordering appliance 112 as described above. Moreover, one skilled in the art will readily appreciate that a customer can access the internal communications network 211 to manage his/her orders using a variety of methods and/or devices in addition to the ordering appliance 112 at one of the retail facilities 104. For example, a user can access the internal communications network 211 to manage an order via electronic mail 224, via a facsimile 226, or via a telephone 228. Additionally, the customer can access the internal communications network 211 via the communications network 110, for example, via the Internet.

A firewall 230 secures the network 211 and the data and application software residing on the various computing servers from unauthorized access. All data that attempts to pass through (e.g., either into or out of the internal communications network 211) the firewall 230 is required to meet specified security criteria. A router 232 connects the internal communications network 211 to an Internet service provider (“ISP”) router 244 that provides an additional method for the customer to access the internal communications network 211. Data is sent and received from the network 211 via communication carriers 243 and 245, respectively. In one embodiment, the communication carriers 243 and 245 are dedicated phone connection systems that allow high-speed Internet connections, such as a T1 carrier or a T3 carrier.

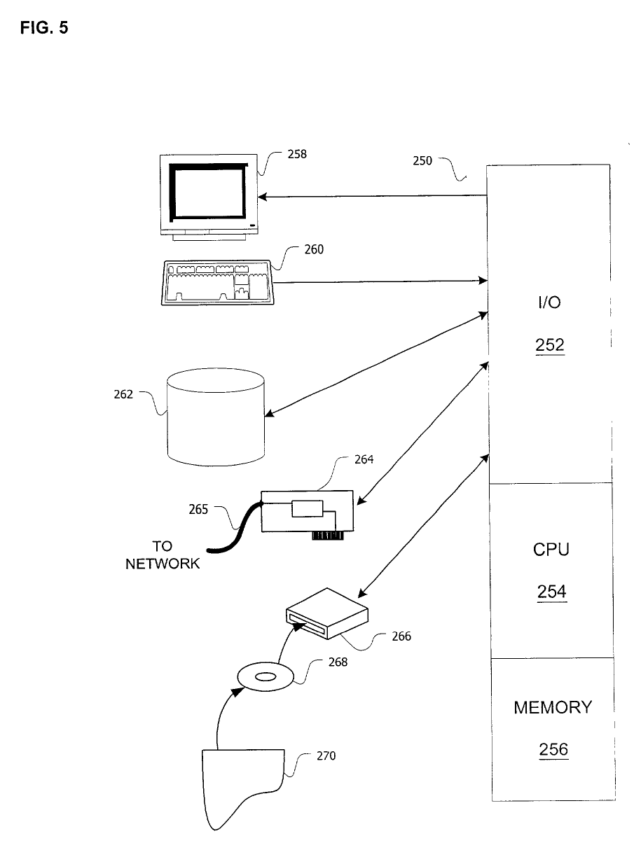

FIG. 5 depicts a general purpose computer capable of implementing the sales and distribution computing system 108 according to the principles of the present disclosure. In the illustrated embodiment, data and program files may be input to the computer, which reads the files and executes the programs therein. Some of the elements of the general purpose computer shown in FIG. 5 can include a processor 250 having an input/output (“I/O”) section 252, a central processing unit (“CPU”) 254, and a memory section 256. The present invention is optionally implemented in software devices loaded in memory 256 and/or stored on a configured CD-ROM 268 or storage unit 262 thereby transforming the computer system in FIG. 5 to a special purpose machine for implementing the sales and distribution system 108 of the present disclosure.

The I/O section 252 is connected to a display unit 258, a keyboard 260, a disk storage unit 262, and a disk drive unit 266. Generally, in contemporary systems, the disk drive unit 266 is a CD-ROM driver unit capable of reading the CD-ROM medium 268, which typically contains programs 270 and data. Computer program products containing mechanisms to effectuate the systems and methods in accordance with the present invention may reside in the memory section 256, on a disk storage unit 262, or on the CD-ROM medium 268 of such a system. Alternatively, the disk drive unit 266 may be replaced or supplemented by a floppy drive unit, a tape drive unit, or other storage medium drive unit. The network adapter 264 is capable of connecting the computer system to a network, such as the internal communications network 211 (FIG. 4), via the network link 265.

FIG. 6 depicts an exemplary ordering appliance 112 capable of communicating with and accessing the sales and distribution computing system 108 (FIG. 2) according to the principles of the present disclosure. As described above, the ordering appliance 112 is preferably a dedicated computing system used by a customer for the purpose of accessing the sales and distribution computing system 108 (FIG. 2). For example, the ordering appliance 112 can be any dedicated IBM-compatible personal computer, a laptop computer, workstation, palm- or hand-held computer, or any other device that can be used to access the sales and distribution computing system 108 (FIG. 2) via the communications network 114 (FIG. 2). However, it should be understood that the ordering appliance 112 can be any other suitable device capable of communicating with and accessing the sales and distribution computing system 108 (FIG. 2).

In the illustrated embodiment, the ordering appliance 112 includes a screen/input device 270, a processor 272, and a memory section 280. The processor 272 includes an input/output section 274, a CPU 276 operable with conventional computer memory 278. The input/output section 274 is configured to receive input from and display output to various input/output devices, components, or modules. For example, the input/output section 274 is configured to operate with the screen/input device 270. Thus, in this embodiment, the screen/input device 270 can operate as an input device or an output device. Furthermore, the input/output section 274 can be configured to receive input from a voice recognition device (not shown) operable with the ordering appliance 112.

Additionally, the input/output section 274 can be configured to operate with optional devices, such as a speaker 286, a microphone 288, a modem 290, a barcode scanner/digital signal reader 292, memory 294 for additional information storage, an additional storage area 296, or a printer 299 that can be used to print out a receipt or some other confirmation of the customer's order. Similarly, the ordering appliance 112 can be provided with a communications port 298 for communicating or interfacing with the communications network 114 (FIG. 2) or any other computer or network. The communications port 298 can include an antenna for radio frequency communications, an infrared lens for infrared communications, or a port for direct physical attachment to the communications network 114 (FIG. 2) or any other computer or network.

The ordering appliance 112 also includes a memory section 280 for storing information accessible by the ordering appliance 112. The memory section 280 can include a read-only memory section (“ROM”) 282 and random access memory section (“RAM”) 284. In one embodiment, the information stored by the memory section 280 can include applications that can be executed by the ordering appliance 112. Furthermore, the ordering appliance 112 preferably can include a web browser installed for accessing and viewing content information transferred from the communications network 114 (FIG. 2) or any other suitable computing network. For example, the ordering appliance 112 can includes a web browser, such as those sold under the brand names Microsoft Internet Explorer™ or Netscape Navigator™.

Now referring to FIG. 7, a detailed diagram illustrating the various components of the system and method of the present disclosure is shown. As discussed above, a customer can access the sales and distribution computing system 108 to place an order for consumer products by visiting one of the available retail facilities 102. In the embodiment illustrated in FIG. 7, the retail facility 102 can include a collection of ordering appliances 112a-112d. It will be appreciated by those having skill in the art that the number of ordering appliances 112 available at each of the retail facilities 102 can vary according to various factors, including, the number of vendors 106 (FIG. 1) affiliated with the retail facility 102, the size of the retail facility 102, the amount of customer traffic expected at the retail facility 102, as well as other similar factors.

The consumer products available from each of the vendors 106 (FIG. 1) typically comprises each vendor's entire product offering. However, as noted above, in traditional settings, the amount of retail space required to display and/or otherwise make available the vendor's entire product offering is very large and, therefore, costly. Additionally, many vendors typically maintain an inventory of each product in a storage or warehouse facility located adjacent to the retail area. Accordingly, vendors operating in traditional retail environments must make a substantial investment in retail space and inventory, thereby, increasing their overall costs to operate.

The system and method of the present disclosure minimizes the costs associated with traditional retail environments by making available only a sampling of each vendor's entire product offering at each of the retail facilities 102. For example, the retail facility 102 can make available sample products 109a-109d that would be representative of a vendor's entire product offering for each vendor 106a-106d offering products via the sales and distribution computing system 108. In so doing, a customer attempting to purchase a product at one of the ordering appliances 112a-112d can inspect a representative product sample before making his/her purchase without the need for the retail facility 102 to maintain the vendor's entire product offering. As a result, the amount of retail space required for each retail facility 102 is greatly reduced while still providing the customer with the ability to personally inspect a representative product from the vendor 106.

In one possible embodiment, each of the ordering appliances 112a-112d is associated with a single vendor. Thus, for example, in a retail facility 102 having affiliations with multiple different vendors 106 (FIG. 1), a single ordering appliance 112 can be dedicated to each of the different vendors 106. In an alternative embodiment, however, the ordering appliances 112a-112d can be situated and arranged such that there is a relationship between any particular ordering appliance 112 and any particular group of vendors 106. In the embodiment illustrated in FIG. 7, each vendor's sample product(s) 109a-109d are shown situated proximate to at least one of the ordering appliances 112a-112d available within the retail facility 102. In this case, the customer can approach the ordering appliance 112 corresponding to the desired vendor 106 to place his/her order. For example, the customer can approach a first ordering appliance 112a to order products corresponding to a first vendor 106a having a vendor computing system 120a. The customer can also inspect the vendor's representative product sample 109a to gain familiarity with the vendor and/or a particular product to assist with his/her ordering decision prior to or while placing the order. In so doing, the customer can place orders with any of the vendors 106a-106d having an affiliation with the retail facility 102 in a time-efficient manner.

Additionally, one or more sales associates 105 can be available to assist the customer with his/her purchase. It is contemplated that each of the sales associates 105 will be knowledgeable and/or familiar with each of the vendors 106 (FIG. 1) as well as the products being offered. Accordingly, if the customer has a question about a particular vendor (e.g., vendors 106a-106d) or the vendor's product(s), the customer can seek assistance from one of the available sales associates 105. Thus, human interaction is available to assist each customer in making a purchase decision.

Referring now to FIG. 8, a diagram illustrating the delivery modalities supported by the system and method of the present disclosure are shown. The phrase “delivery modalities” refers to the various delivery options available to a customer when making a purchase using the sales and distribution computing system 108 (FIG. 2). For example, as shown in FIG. 8, when a customer places an order using the sales and distribution computing system 108 (FIG. 2), the customer can specify how that product will be delivered from the vendor 106 (FIG. 1).

The embodiment illustrated in FIG. 8 illustrates at least three possible delivery modalities supported by the system and method of the present disclosure. For example, a first delivery modality 130 allows a first customer 103a to select to have his/her order delivered directly to a customer-selected delivery location. For example, the first customer 103a can select to have his/her order delivered to his/her home address, work address, or any other delivery location. A second delivery modality 132 allows a second customer 103b to select to have his/her order delivered to one of the retail facilities 102 using a second delivery modality 132. For example, the second customer 103b can select to have his/her customer order delivered to the retail facility 102 where the order was originally made or, alternatively, to a more convenient retail facility 102. A third delivery modality 134 can be used when the vendor requires delivery of the products to a secured location, such as, one of the retail facilities 102. The third delivery modality 134 might be used in situations where the product being ordered by the customer 103c is uniquely valuable (e.g., “one-of-a-kind” articles) and, therefore, the vendor 106 requires the customer 103c to personally take possession of the customer order.

The delivery modalities 130, 132, 134 significantly improve the level of service to and satisfaction of each of the customers accessing the system and method of the present disclosure. In particular, where the order is delivered to the retail facility 102, each of the retail facilities 102 can serve as an intermediary between the customers and each of the vendors 106 (FIG. 1). As such, each of the retail facilities 102 can be equipped to allow the customers to personally inspect the product(s) before they take possession of the order. Therefore, the customer can feel confident that if problems with the product(s) exist, immediate action can be taken to remedy the situation. For example, each of the retail facilities 102 can return the customer's order to the appropriate vendor 106 (FIG. 1) in the event the customer finds the product to be defective or otherwise unsatisfactory. Similarly, each of the retail facilities 102 can coordinate repair and/or refurbishment of the product(s). Accordingly, the system and method of the present disclosure eliminates much of the frustration often felt by customers when ordering consumer products via a computing system, such as, in an on-line environment.

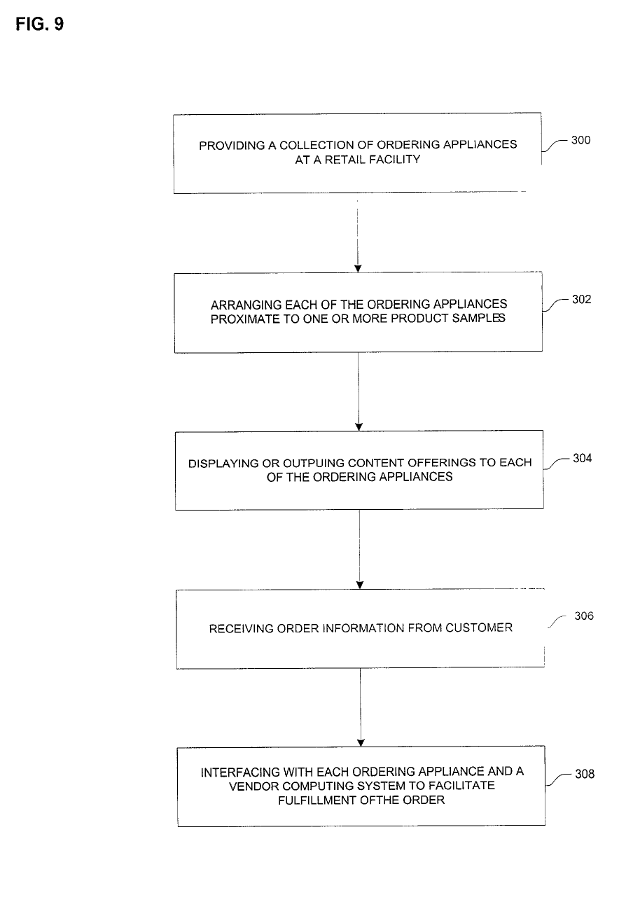

FIG. 9 illustrates a high-level flow diagram of the logical operations of the system and method of the present disclosure. As illustrated in FIG. 9, a collection of ordering appliances 110 can be provided at a retail facility 102 as shown at operation 300. Further, as discussed above, the retail facilities 102 can be a part of a network of retail facilities 104. The ordering appliances 112 at each of the retail facilities 102 can be arranged proximate to one or more product samples at operation 302 as discussed above. Operation 304 displays or outputs content offerings 115 associated with one of the vendors 106 to an ordering appliances 112. In one possible embodiment, the content offerings 115 associated with one of the vendors 106 can be varied according to the retail facility 102 or according to each retail facility 102 within a network of retail facilities 104. In response to the content offerings 115, operation 306 receives order information 111 that has been input into one of the ordering appliances 112 by a customer.

Once the order information 111 has been received, operation 308 provides an interface between the ordering appliance 112 and a corresponding vendor computing system 120 associated with the selected vendor 106 to facilitate the fulfillment of the customer's order. In one possible embodiment, the interface between the ordering appliance 112 and a corresponding vendor computing system 120 can be provided using a translator 122 that dynamically manages the affiliation between the retail facility 102 and each of the vendor computing systems 120 as discussed above. In this embodiment, the translator 122 can tailor the content offerings 115 to the retail facility 102 in accordance with the affiliation established between the retail facility 102 and the more than one vendor 106. For example, the translator 122 can tailor the content offerings 115 according to demographic information gathered for the retail facility 102 or the network of retail facilities 104.

The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which is set forth in the following claims.

The claimed invention is:

1. A system for managing the sale and distribution of consumer products within a retail facility, the consumer products being offered by two or more vendors having an affiliation with the retail facility, the system comprising:
(a) a collection of ordering appliances situated and arranged at the retail facility; each of the ordering appliances being configured to display content offerings and receive order information from a customer placing an order for one or more consumer products being offered by one of the vendors; and
(b) an order management subsystem in data communication with each of the ordering appliances; the order management subsystem comprising an order processor being configured to interface with each of the ordering appliances and a vendor computing system associated with each of the vendors via a computing network.

2. The system according to claim 1, wherein the order processor is further configured to interface with a translator for dynamically managing the affiliation between the retail facility and each of the vendor computing systems.

3. The system according to claim 2, wherein the translator comprises a business web embedded within the order processor.

4. The system according to claim 2, wherein the translator is configured to tailor the content offerings to the retail facility in accordance with the affiliation established between the retail facility and two or more vendors.

5. The system according to claim 4, wherein the translator is further configured to tailor the content offerings according to demographic information gathered for the retail facility.

6. The system according to claim 1, wherein the retail facility comprises a network of retail facilities; each of the retail facilities within the network having an affiliation with two or more vendors.

7. The system according to claim 6, wherein the content offerings associated with each vendor vary at each retail facility within the network of retail facilities.

8. The system according to claim 1, wherein the affiliation with the retail facility defines the content offerings available at the retail facility from the corresponding vendor.

9. The system according to claim 1, wherein each of the ordering appliances comprises a dedicated ordering appliance associated with one of the vendors.

10. The system according to claim 1, wherein each of the vendors having an affiliation with the retail facility offer complementary consumer products.

11. The system according to claim 1, wherein each of the ordering appliances is situated and arranged proximate to one or more product samples; each of the one or more product samples being representative of a complete product offering available from one of the vendors.

12. The system according to claim 1, wherein the order management subsystem further comprises an order fulfillment module in data communication with the order processor; the order fulfillment module being configured to track the fulfillment of the order.

13. A method of selling and distributing consumer products within a retail facility, the consumer products being offered by the retail facility from two or more vendors having an affiliation with the retail facility, the method comprising:
(a) providing a collection of ordering appliances situated and arranged at the retail facility;
(b) displaying content offerings associated with the vendors to at least one of the ordering appliances;
(c) receiving order information from a customer placing an order for one or more consumer products being offered by one or more vendors; and
(d) interfacing with each of the ordering appliances and a vendor computing system associated with each of the vendors via a computing network to facilitate the fulfillment of the order.

14. The method according to claim 13, wherein interfacing with each of the ordering appliances and the vendor computing systems includes providing a translator for dynamically managing the affiliation between the retail facility and each of the vendor computing systems.

15. The method according to claim 14, wherein providing a translator further comprises tailoring the content offerings to the retail facility in accordance with the affiliations established between the retail facility and each of the vendors.

16. The method according to claim 15, wherein tailoring the content offerings to the retail facility further comprises tailoring the content offerings according to demographic information and other sales information gathered for the retail facility.

17. The method according to claim 13, wherein the retail facility comprises a network of retail facilities; each of the retail facilities within the network having an affiliation with more than one vendor.

18. The method according to claim 17, the method further comprising varying the content offerings according to each retail facility within the network of retail facilities.

19. The method according to claim 13, wherein providing a collection of ordering appliances includes providing a collection of dedicated ordering appliances each being associated with one of the vendors.

20. The method according to claim 13, the method further comprising arranging each of the ordering appliances proximate to one or more product samples; each of the one or more product samples being representative of a complete product offering available from one of the vendors.

21. The method according to claim 13, the method further comprising providing a source of additional information to assist the customer.

22. The method according to claim 13, the method further comprising tracking the fulfillment of the order.
